(19) United States
(12) Patent Application Publication
(10) Pub. No.: US 2011/0249423 A1
(43) Pub. Date: Oct. 13, 2011

(54) Lighting Keyboard

(75) Inventors: Hsuan-Wei Ho, Taipei City (TW); Liang-Yu Yao, New Taipei City (TW)

(73) Assignee: DARFON ELECTRONICS CORP., Taoyuan Shien (TW)

(21) Appl. No.: 13/075,963

(22) Filed: Mar. 30, 2011

(30) Foreign Application Priority Data
Apr. 7, 2010 (TW) 99206118

(51) Int. Cl. F21V 33/00

(52) U.S. Cl. 362/85

(57) ABSTRACT

A lighting keyboard includes a light emitting module, a keyboard module and a masking film. The keyboard module is disposed on the light emitting module. The masking film is disposed between the light emitting module and the keyboard module. The masking film includes a first optical layer and a second optical layer. The first optical layer has several first openings. The second optical layer is disposed on a surface of the first optical layer. The surface of the first optical layer faces the light emitting module. A portion of the second optical layer is exposed from the first openings. A light shielding rate of the first optical layer is larger than a light shielding rate of the second optical layer.

This application claims the benefit of Taiwan application Serial No. 099206118, filed Apr. 7, 2010, the subject matter of which is incorporated herein by reference.

### BACKGROUND OF THE INVENTION

1. Field of the Invention

The invention relates in general to a lighting keyboard, and more particularly to a lighting keyboard with a masking film.

2. Description of the Related Art

In order to provide the functions for inputting data to an electronic device and operating the electronic device, various input devices are widely used. For example, the input device may be a keyboard or a touch pad. For the keyboard, a lighting keyboard can be used in the environment where the illumination light is not sufficient, and has thus become the mainstream of application.

Generally speaking, the lighting keyboard includes a keyboard module, a mask board and a light emitting module. The mask board is disposed between the keyboard module and the light emitting module. The mask board has several holes. The positions of the holes correspond to the positions of the keys, so that the light generated by the light emitting module can pass therethrough and be projected onto the corresponding key of the key module. Consequently, the key can emit light so that the user can easily recognize the position of the key.

However, a portion of the light generated by the light emitting module may be directly projected out without passing through the key. Consequently, the eyes of the user may feel uncomfortable because the light is directly projected onto the eyes. Thus, it is an important subject of the manufacturer to provide a lighting keyboard capable of preventing the light from affecting the user and capable of enhancing the convenience in use.

### SUMMARY OF THE INVENTION

The invention is directed to a lighting keyboard for effectively preventing the light from being directly projected onto the user according to the arrangement of the exposed portion. Consequently, the uncomfortable feeling and the inconvenience of the user can be decreased.

According to the present invention, a lighting keyboard including a light emitting module, a keyboard module and a masking film is provided. The keyboard module is disposed on the light emitting module. The masking film disposed between the light emitting module and the keyboard module includes a first optical layer and a second optical layer. The first optical layer has a plurality of first openings. The second optical layer is disposed on a surface of the first optical layer. The surface of the first optical layer faces the light emitting module. A portion of the second optical layer is exposed from the first openings, and a light shielding rate of the first optical layer is larger than a light shielding rate of the second optical layer.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic illustration showing a lighting keyboard according to a first embodiment of the invention.

FIGS. 2A and 2B are schematic illustrations showing a masking film of FIG. 1 at different viewing angles.

FIG. 3 is a schematic illustration showing a light projecting path of a light emitting module of FIG. 1.

FIG. 4 is a schematic illustration showing a masking film according to a second embodiment of the invention.

FIGS. 5A and 5B are schematic illustrations showing a masking film at different viewing angles according to a third embodiment of the invention.

FIG. 6 is a schematic illustration showing a light projecting path of a light emitting module according to the third embodiment of the invention.

### DETAILED DESCRIPTION OF THE INVENTION

The invention provides a lighting keyboard including a light emitting module, a keyboard module and a masking film. The keyboard module is disposed on the light emitting module. The masking film disposed between the light emitting module and the keyboard module includes a first optical layer and a second optical layer. The first optical layer has a plurality of first openings. The second optical layer is disposed on a surface of the first optical layer. The surface of the first optical layer faces the light emitting module. A portion of the second optical layer is exposed from the first openings, and a light shielding rate of the first optical layer is larger than a light shielding rate of the second optical layer. The lighting keyboard of the invention will be described in the following according to several embodiments in conjunction with the drawings. However, those skilled in the art may understand that the drawings and texts are for the illustrative purpose only, but do not intend to restrict the scope of the invention.

### First Embodiment

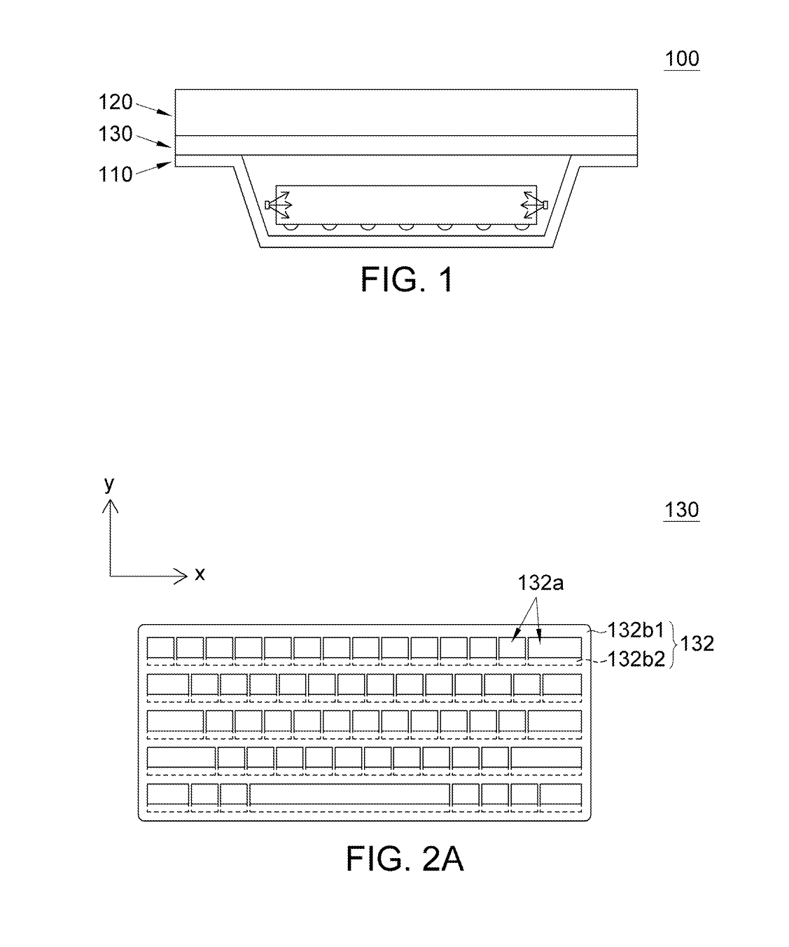

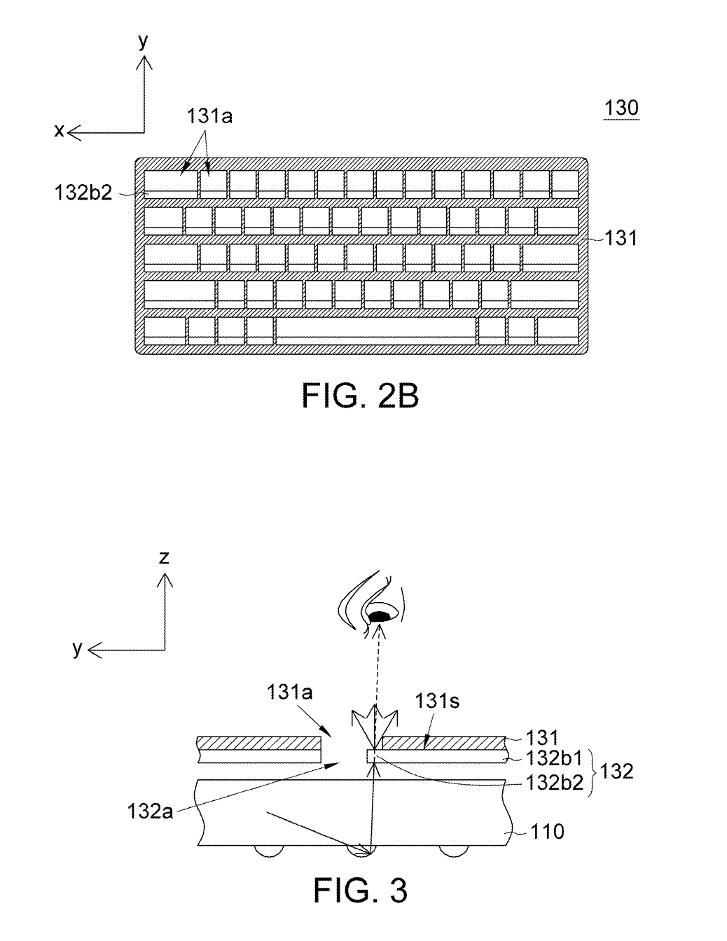

Please refer to FIGS. 1, 2A, 2B and 3. FIG. 1 is a schematic illustration showing a lighting keyboard 100 according to a first embodiment of the invention. FIGS. 2A and 2B are schematic illustrations showing a masking film 130 of FIG. 1 at different viewing angles. FIG. 3 is a schematic illustration showing a light projecting path of a light emitting module 110 of FIG. 1. In order to express the technological characteristics of this embodiment clearly, some elements of the lighting keyboard 100 are omitted from FIG. 3.

The lighting keyboard 100 includes the light emitting module 110, a keyboard module 120 and the masking film 130. The keyboard module 120 is disposed on the light emitting module 110. The masking film 130 is disposed between the light emitting module 110 and the keyboard module 120.

The masking film 130 includes a first optical layer 131 (the hatched element) and a second optical layer 132. The first optical layer 131 has several first openings 131a. The second optical layer 132 is disposed on a surface 131s of the first optical layer 131, and the surface 131s faces the light emitting module 110. The positions of second openings 132a correspond to the positions of the first openings 131a. The size of each second opening 132a is smaller than the size of the corresponding first opening 131a, so that one portion of the second optical layer 132 is exposed from the first openings 131a. The positions of the first opening 131a and the second opening 132a correspond to the position of the key of the keyboard module 120. Consequently, the light provided by the light emitting module 110 can pass through the second opening 132a and the first opening 131a and then be projected onto the key to make the key emit light.

The way of exposing the portion of the second optical layer 132 from the first opening 131a according to this embodiment will be further be described in the following. The second optical layer 132 includes a main body 132b1 and several exposed portions 132b2. The main body 132b1 has several openings. The exposed portion 132b2 is disposed in the opening of the main body 132b1 and thus connected to the main body 132b1 to form the second opening 132a. The area of the main body 132b1 of this embodiment is substantially equal to the area of the first optical layer 131. In addition, for the arrangement relationship, the position of the main body 132b1 substantially corresponds to the position of the first optical layer 131, and the position of the first opening 131 a also substantially corresponds to the position of the opening of the main body 132b1. Consequently, one exposed portion 132b2 is exposed from the corresponding first opening 131a.

As shown in FIG. 3, generally speaking, the conventional masking film does not have the exposed portion. Thus, the light may be possibly projected onto the user's eyes directly, as indicated by the dashed line arrow, so that the user feels uncomfortable. In this embodiment, the exposed portion 132b2 is exposed from the first opening 131a. Thus, the exposed portion 132b2 can diverge (diffuse) the projected light. Consequently, it is possible to prevent the light from being directly projected onto the user's eyes. For the experimental results, the arrangement of the exposed portion 132b2 can provide the function similar to the diffuser to lower the light leakage of about 60% and to uniformly diverge the light.

In this embodiment, the light shielding rate of the first optical layer 131 is larger than the light shielding rate of the second optical layer 132. That is, the material of the first optical layer 131 may include black ink, for example, and the material of the second optical layer 132 may include white ink, for example. Consequently, the first optical layer 131 including the black ink can provide the light shielding effect to prevent the light from emitting from the position other than the key. In addition, the second optical layer 132 including the white ink can increase the light usage.

### Second Embodiment

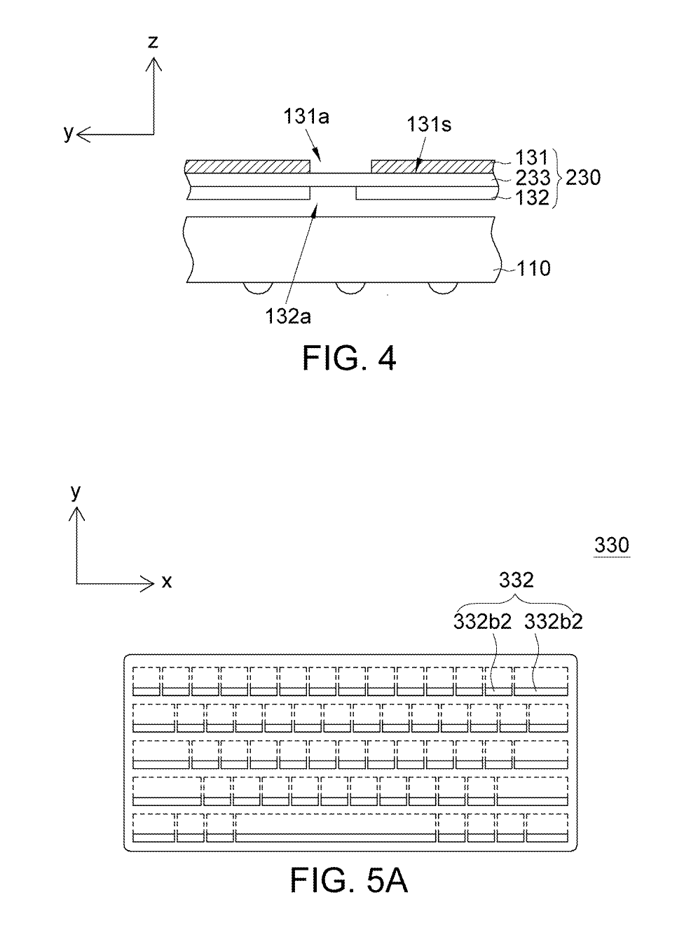

FIG. 4 is a schematic illustration showing a masking film 230 according to a second embodiment of the invention. Compared with the masking film 130 of the first embodiment, the masking film 230 of this embodiment further includes a substrate 233. The first optical layer 131 and the second optical layer 132 are respectively disposed on two opposite surfaces of the substrate 233, so that the second optical layer 132 is disposed on the surface 131s of the first optical layer 131 through the substrate 233. Consequently, the masking film 230 of this embodiment may also provide the advantages similar to those of the masking film 130 of the first embodiment.

### Third Embodiment

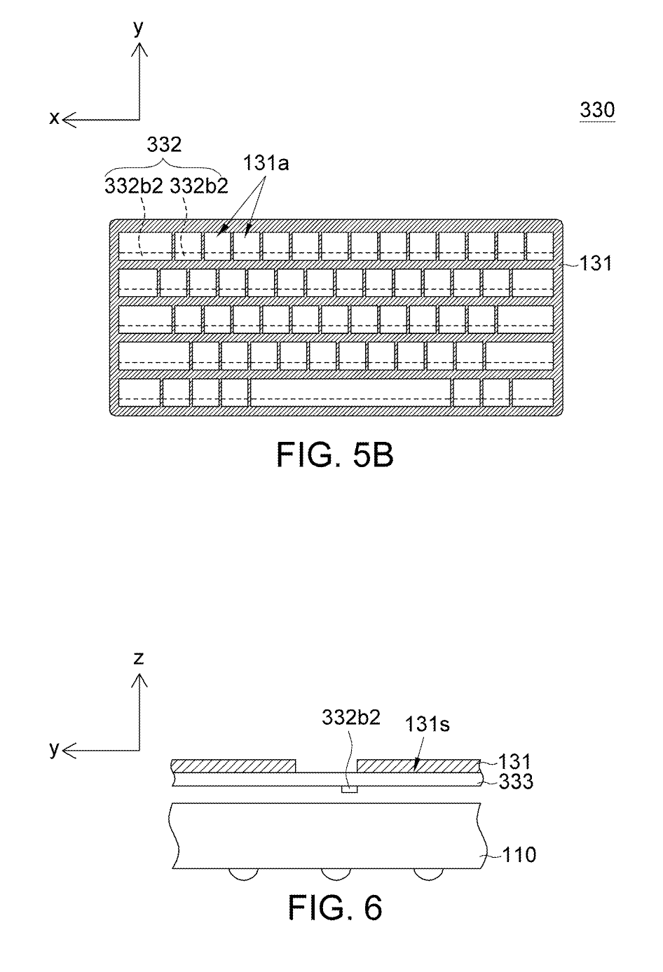

Please refer to FIGS. 5A, 5B and 6. FIGS. 5A and 5B are schematic illustrations showing a masking film 330 at different viewing angles according to a third embodiment of the invention. FIG. 6 is a schematic illustration showing a light projecting path of the light emitting module 110 according to the third embodiment of the invention. Compared with the masking film 130 of the first embodiment, the masking film 330 of this embodiment further includes a substrate 333. The first optical layer 131 and a second optical layer 332 are respectively disposed on two opposite surfaces of the substrate 333, so that the second optical layer 332 is disposed on the surface 131s of the first optical layer 131 through the substrate 333. In addition, the second optical layer 332 includes several exposed portions 332b2 separated from each other. Because one exposed portion 332b2 is exposed from the corresponding first opening 131a, the masking film 330 of this embodiment may also provide the advantages similar to those of the masking film 130 of the first embodiment.

In the lighting keyboard according to each embodiment of the invention, the configuration of exposing the exposed portion of the second optical film from the first opening is adopted to effectively prevent the light from projecting onto the user directly. Consequently, the uncomfortable feeling and the inconvenience of the user can be decreased. In one embodiment, several exposed portions are connected together through the main body to increase the efficiency in assembly. In another embodiment, several exposed portions are separated from each other to decrease the material cost. In the above-mentioned embodiments, only one exposed portion is exposed from one first opening. However, those skilled in the art may easily understand that the number of the exposed portions and the positions of the exposed portions disposed at the first openings may be determined according to the light projecting path and the convenience of the user.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lighting keyboard, comprising:
a light emitting module;
a keyboard module disposed on the light emitting module; and
a masking film disposed between the light emitting module and the keyboard module, the masking film comprising:
a first optical layer having a plurality of first openings; and
a second optical layer disposed on a surface of the first optical layer, wherein the surface of the first optical layer faces the light emitting module, a portion of the second optical layer is exposed from the first openings, and a light shielding rate of the first optical layer is larger than a light shielding rate of the second optical layer.

2. The lighting keyboard according to claim 1, wherein the second optical layer has a plurality of second openings, the positions of the second openings respectively correspond to the positions of the first openings, and a size of each of the second openings is smaller than a size of the corresponding first opening.

3. The lighting keyboard according to claim 1, wherein the second optical layer comprises:
a main body; and
a plurality of exposed portions connected to the main body to form a plurality of second openings, wherein one of the exposed portions is exposed from the corresponding first opening.

4. The lighting keyboard according to claim 3, wherein an area of the main body is substantially equal to an area of the first optical layer.

5. The lighting keyboard according to claim 1, wherein the second optical layer comprises a plurality of exposed portions, and one of the exposed portions is exposed from the corresponding first opening.

6. The lighting keyboard according to claim 5, wherein the exposed portions are separated from each other.

7. The lighting keyboard according to claim 1, wherein a material of the second optical layer comprises white ink.

8. The lighting keyboard according to claim 1, wherein a material of the first optical layer comprises black ink.

9. The lighting keyboard according to claim 1, wherein the masking film further comprises:
a substrate, wherein the first optical layer and the second optical layer are respectively disposed on two opposite surfaces of the substrate, so that the second optical layer is disposed on the surface of the first optical layer through the substrate.
